(19) United States
(12) Patent Application Publication
(10) Pub. No.: US 2002/0186635 A1
(43) Pub. Date: Dec. 12, 2002

(54) Optical pickup

(75) Inventor: Tatsuji Eda, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Sony Corporation, Tokyo (JP)

(21) Appl. No.: 10/150,933

(22) Filed: May 21, 2002

(30) Foreign Application Priority Data
May 24, 2001 (JP) 2001-155251

(51) Int. Cl. G11B 7/00

(52) U.S. Cl. 369/53.2; 369/116

(57) ABSTRACT

An optical pickup includes two laser diodes having different wavelengths compatible with two types of optical disc, DVDs and CDs. The optical pickup also includes a photodetector for detecting the laser power of each of the laser diodes and two adjusters for adjusting a detection signal of the photodetector according to the level of the laser power. Further, a switch for selecting the output of each of the two adjusters is provided in the optical pickup. In a process for manufacturing the optical pickup, adjustment is performed by using the two adjusters, while monitoring the output obtained through the switch. Accordingly, the adjustment can be achieved without being affected by variations in the characteristics of the switch when the optical pickup is actually used.

### BACKGROUND OF THE INVENTION

1. Field of the Invention

The present invention relates to an optical pickup in which a plurality of laser light-emitting elements are selectively used.

2. Description of the Related Art

Hitherto, digital video disc (DVD) players including a function for playing back compact discs (CD) haye been available. The optical pickup of such apparatuses has two laser light-emitting elements having different wavelengths for DVDs and for CDs. The laser light-emitting elements are selectively used for playing back a DVD or a CD.

In order to control the laser power for the two laser light-emitting elements, a detection signal from a photodetector (PD) is used. Two adjusters for individually adjusting the laser power for each of the DVD and CD using the detection signal of the photodetector (PD) are provided. The output level of the photodetector is adjusted by the two adjusters so that two detection signals are output separately.

Accordingly, in order to incorporate such an optical pickup into an apparatus, a switching element for switching the two detection signals is provided on a mounting board side of the apparatus (hereinafter referred to as an apparatus board) and one of the detection signals adjusted by the two adjusters is selected by the switching element so that the laser power of each laser light-emitting element is controlled (see Japanese Unexamined Patent Application Publication Nos. 8-147744 and 2001-28140, for example).

FIG. 3 is a block diagram showing the configuration of a laser drive circuit and the vicinity thereof in a known optical pickup for DVDs. The left side shows the configuration inside an optical pickup 10 and the right side shows the configuration of an apparatus board 30 side, with the broken line B being the center.

As shown in FIG. 3, the optical pickup 10 includes a DVD laser diode 12, a CD laser diode 14, a photodetector (PD) 16 for controlling the laser power, and two adjusters 20 and 22 for adjusting the detection signal of the photodetector 16 to a different level.

On the other hand, the apparatus board 30 side includes an automatic laser power control (APC) block 32 and a switch (SW) 34 for selecting the adjuster 20 or 22.

By controlling the switch 34 with a CD/DVD control signal according to the selection of DVD or CD, the detection signal adjusted by the adjuster 20 or 22 is selected and laser power control is performed by the APC block 32 based on the selected detection signal.

However, in the known optical pickup 10, the detection signal adjusted by the adjuster 20 or 22 on the optical pickup 10 side is selected by the switch 34 provided on the apparatus board 30 side, and thus an error may be generated in the detection signal due to variations in the characteristics of the switch 34.

That is, the switch 34 comprises a circuit using, for example, a field-effect transistor (FET), and the ON resistance of the FET naturally has a predetermined variation.

Consequently, however accurately the adjusters 20 and 22 are adjusted during the manufacturing process of the optical pickup 10, the detection signal varies due to the error generated at the switch 34 when the optical pickup 10 is incorporated into the apparatus, and thus suitable laser power control is prevented.

### SUMMARY OF THE INVENTION

Accordingly, it is an object of the present invention to provide an optical pickup in which an accurate detection signal for performing suitable laser power control can be obtained regardless of variations in the characteristics of a switch for switching the detection signal when the optical pickup is incorporated into an apparatus.

In order to achieve the above-described object, the optical pickup of the present invention comprises a plurality of laser light-emitting elements; a photodetector for receiving laser light radiated from the plurality of laser light-emitting elements and monitoring the power of the radiated laser light; a plurality of adjusters for adjusting the power of the radiated laser light from the plurality of laser light-emitting elements via the photodetector; and a switch for selecting one of the plurality of adjusters.

In the optical pickup of the present invention, the detection signal for controlling each of the plurality of laser light-emitting elements is adjusted by each of the plurality of adjusters and is output. The detection signal adjusted by each of the adjusters is selected by the switch provided in the optical pickup and the selected detection signal is output from an output terminal.

With this arrangement, the detection signal adjusted by each adjuster can be selected and monitored by switching the switch in the optical pickup. Accordingly, the optimum adjustment, including variations in the characteristics of the switch, can be achieved using each of the adjusters.

After the optical pickup is incorporated into the apparatus after the adjustment, the detection signal adjusted by each adjuster is output through the same switch in the optical pickup. Thus, when the optical pickup is actually used, control of laser power can be performed by using the adjusted detection signal having the same characteristic as in the adjustment. Accordingly, the effect of variations in the characteristics of the switch can be eliminated and stable laser power control can be achieved.

### BRIEF DESCRIPTION OF THE DRAWINGS

FIG. 1 is a block diagram showing an example of a configuration of a laser drive circuit and the vicinity thereof in an optical pickup for DVDs according to an embodiment of the present invention;

FIG. 2 is a circuit diagram showing an example of a configuration of a switch of the optical pickup for DVDs shown in FIG. 1; and

FIG. 3 is a block diagram showing an example of a configuration of a laser drive circuit and the vicinity thereof in a known optical pickup for DVDs.

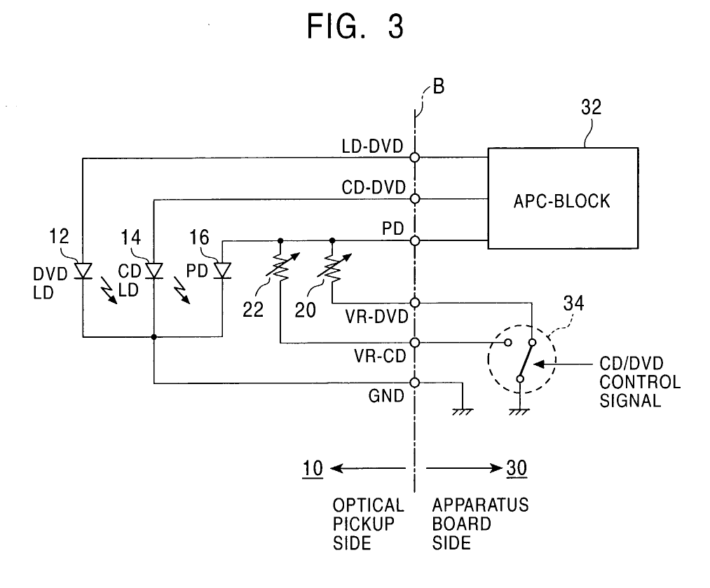

### DESCRIPTION OF THE PREFERRED EMBODIMENT

Hereinafter, an embodiment of an optical pickup according to the present invention will be described.

The embodiment described below is a preferred specific example of the present invention and includes various limitations which are technically preferable. However, the scope of the present invention is not limited to the embodiment as long as the following description does not include a particular description for limiting the present invention.

In the embodiment, the case where the present invention is applied to an optical pickup for DVDs loaded in a DVD player that is compatible with both DVDs and CDs is described.

In the DVD player for both DVDs and CDS, two types of optical disc, a DVD and a CD, must be played back by using lasers having wavelengths of 650 nm and 780 nm, respectively, so the optical pickup for DVDs includes two laser diodes, one of each wavelength. Also, the optical pickup has a photodetector and two adjusters for individually adjusting the laser power of each of the laser diodes.

In the known optical pickup, one of two detection signals adjusted by the two adjusters is selected by the switch provided in the external apparatus board side (apparatus board refers to a mounting board of an apparatus). On the other hand, in the embodiment, a switch for selecting one of two detection signals adjusted by the two adjusters is provided in the optical pickup.

Accordingly, in a process for manufacturing the optical pickup, the laser power of each of the laser diodes is adjusted by the two adjusters while the detection signal of the laser power obtained through the switch is monitored so that the optimum value of the laser power, including variations in the characteristics of the switch, is obtained.

Thus, switching control by a separate switch is not performed during product assembly, and thus an optical pickup that is not affected by variations in the characteristics of the switch while in use is obtained.

Hereinafter, a specific example of the optical pickup according to the embodiment will be described with reference to the drawings.

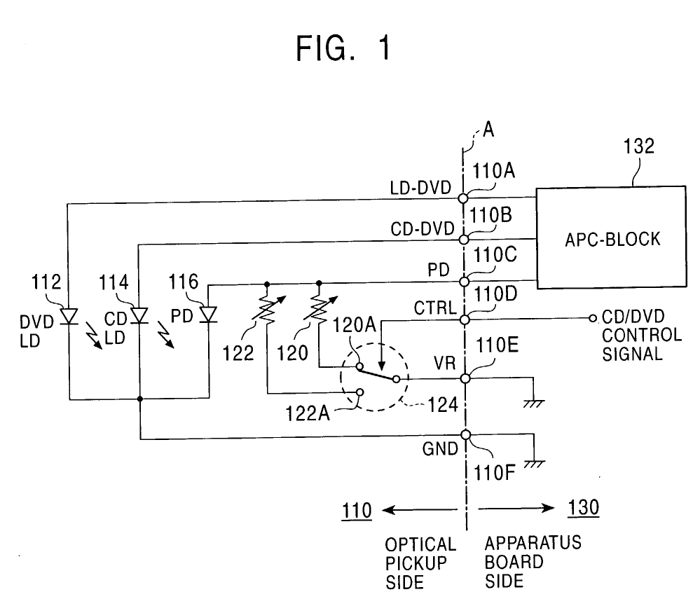

FIG. 1 is a block diagram showing an example of a configuration of a laser drive circuit and the vicinity thereof in the optical pickup for DVDs according to the embodiment. The left side shows the configuration inside the optical pickup 110 and the right side shows the configuration of the apparatus board 130 side, with the broken line A being the center.

As shown in FIG. 1, the optical pickup 110 includes a DVD laser diode 112, a CD laser diode 114, a photodetector (PD) 116 for controlling the laser power, two adjusters 120 and 122 for adjusting the detection signal of the photodetector 116 to a different level, and a switch (SW) 124 for selecting the adjuster 120 or 122.

In the optical pickup 110, the switch 124 is controlled by a CD/DVD control signal input from an input terminal 110D in accordance with the selection of DVD or CD, and then a detection signal VR-DVD or VR-CD, which is adjusted by the adjuster 120 or 122, is selected. Then, the selected detection signal is output from an output terminal 110E to the apparatus board 130 side.

On the other hand, the apparatus board 130 side includes an automatic laser power control (APC) block 132.

The APC block 132 supplies driving signals LD-DVD and CD-DVD to the laser diodes 112 and 114 through input terminals 110A and 110B respectively, of the optical pickup 110, and also supplies a driving signal PD to the photodetector (PD) 116 through an input terminal 110C.

In the apparatus board 130 side, a detection signal VR, which is selected by the switch 124 to be output from the output terminal 110E of the optical pickup 110, is input. Also, control is performed based on the detection signal VR so that the driving signals LD-DVD and CD-DVD for the laser diodes 112 and 114 are maintained at the optimum values.

Also, the apparatus board 130 side is provided with a controller (not shown), the controller supplies a CD/DVD control signal for controlling the switch 124, and the CD/DVD control signal is input to the switch 124 through the input terminal 110D of the optical pickup 110.

Further, the optical pickup 110 is grounded in the apparatus board 130 side, via a GND terminal 110F.

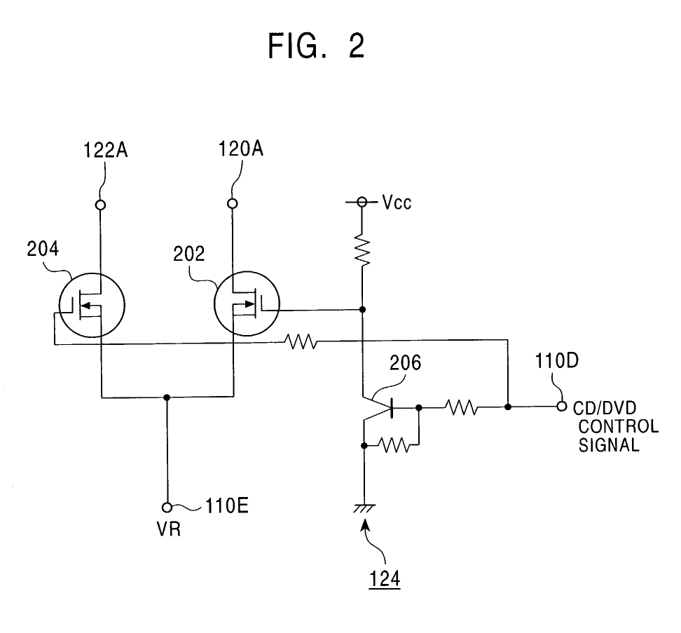

FIG. 2 is a circuit diagram showing an example of a configuration of the switch 124 in the example.

The switch 124 includes two FETs 202 and 204, a bipolar transistor 206, and so on.

The FET 202 is inserted between the output terminal 120A of the adjuster 120 and the output terminal 110E of the optical pickup 110, and opens/closes a signal line extending from the adjuster 120 to the output terminal 110E.

The FET 204 is inserted between the output terminal 122A of the adjuster 122 and the output terminal 110E of the optical pickup 110, and opens/closes a signal line extending from the adjuster 122 to the output terminal 110E.

The bipolar transistor 206 constitutes an inversion circuit for inverting the CD/DVD control signal input from the input terminal 110D and operates so as to turn off the FET 202 with the inversion signal (collector output) when the FET 204 is turned on by the CD/DVD control signal, and to turn on the FET 202 with the inversion signal (collector output) when the FET 204 is turned off by the CD/DVD control signal.

In the switch 124 having the above-described configuration, the ON resistance of the FETs 202 and 204 has a certain variation. However, since the switch 124 is provided in the optical pickup, the optimum adjustment can be achieved including the variation in the ON resistance, by suitably adjusting the adjusters 120 and 122 for adjusting the level during the manufacturing process.

Thus, when the optical pickup according to the example is used when integrated into an apparatus, laser power control can be performed based on the signal passing through the same switch 124, and thus the effect of variations in the characteristics of the switch 124 is eliminated. Accordingly, stable laser power control can be performed, and thus a product having increased reliability can be provided.

In the example, the present invention is applied to the optical pickup for a DVD player having a function for playing back a CD. However, the present invention is not limited to the example and the present invention can be widely applied to an optical pickup having a plurality of laser light-emitting elements and selectively outputting the detection signal of each of the laser light-emitting elements by the adjusters.

In addition, the specific configuration of the switch 124 and so on is not limited to the above-described example and can be suitably modified.

As described above, in the optical pickup of the present invention, the detection signals for controlling the plurality of laser light-emitting elements are adjusted by the plurality of adjusters and are output. The detection signal adjusted by each of the adjusters is selected by the switch provided inside the optical pickup and the selected detection signal is output from one output terminal.

Accordingly, the optimum adjustment, including variations in the characteristics of the switch, can be achieved using each of the adjusters. When the optical pickup is actually used, control of laser power can be performed by using the adjusted detection signal having the same characteristic as in the adjustment. Accordingly, the effect of variations in the characteristics of the switch can be eliminated, stable laser power control can be achieved, and thus reliable operation can be realized.

What is claimed is:

1. An optical pickup comprising:
a plurality of laser light-emitting elements;
a photodetector for receiving laser light radiated from the plurality of laser light-emitting elements and monitoring the power of the radiated laser light;
a plurality of adjusters for adjusting the power of the radiated laser light from the plurality of laser light-emitting elements via the photodetector; and
a switch for selecting one of the plurality of adjusters.

2. The optical pickup according to claim 1, wherein each of the plurality of laser light-emitting elements has a characteristic compatible with a different type of optical recording medium.

3. The optical pickup according to claim 1, wherein the switch includes a plurality of field-effect transistors for opening/closing an output terminal of the plurality of adjusters.

4. The optical pickup according to claim 1, wherein the plurality of laser light-emitting elements are laser diodes and the photodetector is a photodiode.

5. The optical pickup according to claim 1, wherein the plurality of laser light-emitting elements include a first laser light-emitting element having a wavelength compatible with DVDs and a second laser light-emitting element having a wavelength compatible with CDs.
